(19) United States
(12) Patent Application Publication
(10) Pub. No.: US 2007/0098238 A1
(43) Pub. Date: May 3, 2007

(54) Imaging methods, imaging systems, and articles of manufacture

(76) Inventor: Pere Obrador, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/264,578

(22) Filed: Oct. 31, 2005

(51) Int. Cl. G06T 7/20

(52) U.S. Cl. 382/128

(57) ABSTRACT

Imaging methods, imaging systems, and articles of manufacture are described. According to one embodiment, an imaging method includes providing a plurality of orientation definitions corresponding to a plurality of respective views of the space, providing a visual representation corresponding to one of the views of a space, providing one of the orientation definitions corresponding to the visual representation, using the one of the orientation definitions, associating the visual representation of the one view with the space, and displaying the visual representation associated with the space.

### FIELD OF THE DISCLOSURE

Aspects of the disclosure relate to imaging methods, imaging systems, and articles of manufacture.

### BACKGROUND OF THE DISCLOSURE

Devices and methods for capturing and experiencing multimedia have made significant improvements in recent decades. The sophistication of electronic hardware and programming have led to improvements with respect to the capturing of media as well as playback of media for a user. For example, processors and storage circuits are capable of operating at increased speeds which permits significant volumes of media to be captured, processed, stored, retrieved and conveyed to a user.

In but one media example, digital cameras have experienced significant improvements in more recent years. Improved imaging sensors, improved image processing, advancements in memory technology as well as reasonable costs have fueled the growth and acceptance of digital cameras worldwide.

The improvements have made media consumption more enjoyable and realistic for users inasmuch as systems are capable of providing users with reduced lag time during media consumption and some systems may provide real time or near real time consumption of media.

At least some aspects of the disclosure provide improved methods and systems for experiencing media.

### SUMMARY

According to some aspects, imaging methods, imaging systems, and articles of manufacture are described.

According to one embodiment, an imaging method comprises providing a plurality of orientation definitions corresponding to a plurality of respective views of a space, providing a visual representation corresponding to one of the views of the space, providing one of the orientation definitions corresponding to the visual representation, using the one of the orientation definitions, associating the visual representation of the one view with the space, and displaying the visual representation associated with the space.

According to another embodiment, an imaging system comprises storage circuitry configured to store image data of a plurality of visual representations of a space, wherein the storage circuitry is further configured to store orientation data comprising a plurality of orientation definitions corresponding to respective ones of the visual representations and indicative of location and directions of a plurality of views of the space utilized to obtain the respective visual representations, and an interface configured to access a request corresponding to one of the orientation definitions and the respective one of the visual representations, and processing circuitry coupled with the interface and the storage circuitry and configured to access the request, to identify image data of the one of the visual representations using the one of the orientation definitions of the request, and to render the image data of the one of the visual representations available for visual depiction responsive to the request.

### DESCRIPTION OF THE DRAWINGS

FIG. 1 is a block diagram of an imaging system according to one embodiment.

FIG. 2 is a flow chart of real world or virtual imaging aspects according to one embodiment.

FIGS. 3A-3D are illustrative representations of real world space and exemplary consumption of media according to one embodiment.

FIG. 4A is a graphical representation of exemplary filtering to provide image stabilization according to one embodiment.

FIG. 4B is a graphical representation of a user interface according to one embodiment.

FIG. 5 is an illustrative representation of a virtual representation of a space according to one embodiment.

FIG. 6 is a flow chart of an exemplary method for accessing and consuming media in a real world implementation according to one embodiment.

FIG. 7 is a flow chart of an exemplary method for accessing and consuming media in a virtual implementation according to one embodiment.

FIG. 8 is a flow chart of an exemplary method for searching a database of media according to one embodiment.

FIG. 9 is a flow chart of an exemplary method for associating media data with a space according to one embodiment.

### DETAILED DESCRIPTION

Aspects of the disclosure provide imaging methods, and imaging devices and systems. As described below, some aspects are directed towards methods and systems configured to interact with a space. Exemplary interaction includes associating media captured at an initial moment in time with the space at a later moment in time. The space may be indoors or outdoors and comprise a real world environment or a virtual representation of an environment. Other aspects include methods and systems which merge different representations of a given space to form images. Other aspects of the disclosure are described further below.

As described herein, at least one implementation provides interaction of media with a real world environment. Images may be recorded at different eras and played back in the future using display apparatus to help the user relive past events. The display apparatus may be utilized in historic places,. natural parks, or other areas of interest to permit users to access multimedia taken at any point in space and time and to relive it at the same location. These exemplary aspects permit a user to compare multimedia taken at a certain point in space and time and compare it with the current landscape or other surroundings. Images of family members may be captured and played back at later moments in time. Alternatively, famous images including photographs may be provided in a database and licensed for access in some arrangements.

Additional aspects of the disclosure provide exemplary embodiments for recreating an original experience of a space with a virtual representation of the space. A user may be positioned at a virtual position and looking in a virtual direction corresponding to a location and direction when the media data was generated. The user may control the viewing of images, or alternatively, the display apparatus may control the generation of images or respective audio data (e.g., in a video application). A browsing experience provided by display apparatus in one embodiment attempts to permit the user to relive an experience close to when the data was captured in a virtual setting.

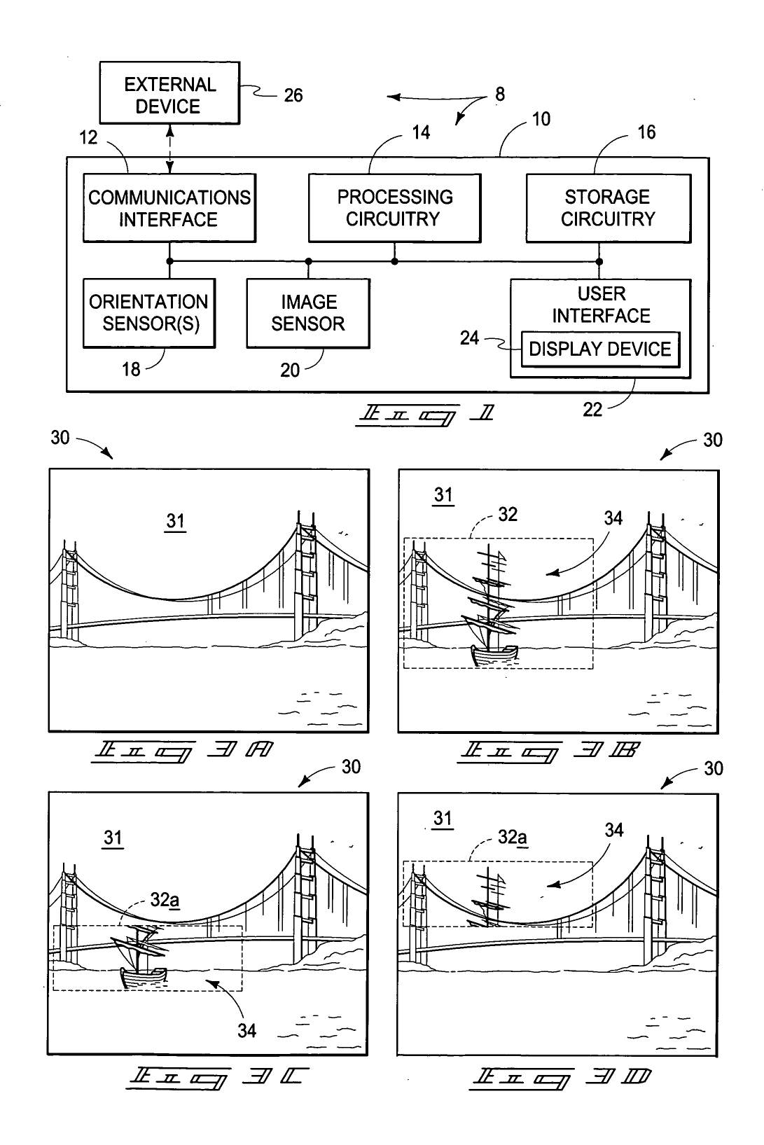

Referring to FIG. 1, an exemplary arrangement of an imaging system 8 according to one embodiment is shown. The depicted system 8 includes a display apparatus 10 configured to communicate with an external device 26. Other configurations of system 8 are possible. For example, external device 26 may be omitted in at least some configurations. In addition, a plurality of display apparatuses 10 and external devices 26 may be provided in other embodiments. In one example, a plurality of display apparatuses 10 may simultaneously communicate with external device 26. In another example, a single display apparatus 10 may communicate with different external devices 26 provided at different physical locations of a space at different moments in time.

Display apparatus 10 is configured to consume media for playback for a user. In one embodiment, display apparatus 10 can generate visual still or video images for viewing by one or more user. Display apparatus 10 may be implemented in different configurations. For example, in one embodiment, display apparatus 110 may be arranged as a portable device configured to interact with a space such as a real world environment (e.g., indoors or outdoors). In another embodiment, display apparatus 10 may be implemented as a personal computer or workstation, for example, for viewing of a virtual representation of a space. Other implementations of display apparatus 10 are possible.

The exemplary configuration of the display apparatus 10 shown in FIG. 1 includes a communications interface 12, processing circuitry 14, storage circuitry 16, orientation sensor(s) 18, an image sensor 20, and a user interface 22. Display apparatus 10 may be configured differently in other embodiments. For example, one or more of the illustrated components may be omitted in other embodiments.

Communications interface 12 is configured to implement communications with respect to one or more external device 26. Communications interface 12 may comprise a wired or wireless connection to implement unidirectional or bidirectional communications in exemplary embodiments.

In one embodiment, processing circuitry 14 is arranged to process data, control data access and storage, issue commands, and control other desired operations. Processing circuitry 14 may manipulate media data and control the consumption of media data (e.g., control a display device 24 to depict visual images). Processing circuitry 14 may comprise circuitry configured to implement desired programming provided by appropriate media in at least one embodiment. For example, the processing circuitry 14 may be implemented as one or more of a processor or other structure configured to execute executable instructions including, for example, software or firmware instructions, or hardware circuitry. Exemplary embodiments of processing circuitry 14 include hardware logic, PGA, FPGA, ASIC, state machines, or other structures alone or in combination with a processor. These examples of processing circuitry 14 are for illustration and other configurations are possible.

Storage circuitry 16 is configured to store electronic data or programming such as executable instructions (e.g., software or firmware), data, or other digital information and may include processor-usable media. Processor-usable media includes any article of manufacture which can contain, store, or maintain programming, data or digital information for use by or in connection with an instruction execution system including processing circuitry 14 in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, or other configurations capable of storing programming, data, or other digital information.

Storage circuitry 16 may comprise a database configured to store multimedia of one or more format. For example, exemplary media may include image data of a plurality of still, panorama or video images to be depicted using display device 24. Stored media may include audio data associated with respective ones of the images and configured for audible playback using user interface 22. As described below, the database of media may be stored elsewhere, for example, using external device 26.

As described further below, the media stored in the database may be indexed based on information indicative of the capture of respective media items (e.g., images, audio data, etc.). This information may comprise metadata of the respective media items and include location information of the device used to capture the data of the media, orientation of the capture device, capture time, or any other efficient metadata representation which may be useful to a user. The data used for indexing respective media items may be referred to as orientation data which are indicative of the capture of the media data of the respective media items by the capture devices. According to one embodiment, exemplary orientation data includes a plurality of orientation definitions for respective media items and which individually include direction information indicative of the orientation of the capture device (e.g., heading, pitch, roll or yaw) at the moment in time in which the media data of a respective media item was captured as well as location information corresponding to the location (e.g., GPS coordinates) of the capture device at the moment of capture of the respective media item.

Exemplary aspects regarding generation and storage of multimedia data along with metadata indicative of the generation of the multimedia data are described in a U.S. patent application having Ser. No. 10/427,614, entitled “Apparatus and Method for Recording “Path-Enhanced” Multimedia”, naming Ramin Samadani and Michael Harville as inventors, filed on Apr. 30, 2003, and having docket number 10019923-1, and the teachings of which are incorporated by reference herein. The incorporated application discloses storage of metadata including location and time information corresponding to the generation of respective multimedia items (e.g., location of camera and time at which the data of individual items was captured). In addition, media capture devices may also include sensors configured to provide information regarding an orientation of the media capture device during the capturing. For example as mentioned above, the metadata may include direction information such as the heading, pitch, roll, or yaw of a camera during capture of image data. As described herein, the metadata may be utilized to index and retrieve the respective media according to some embodiments as described below.

Orientation sensor(s) 18 are configured to provide orientation information regarding display apparatus 10. Exemplary configurations of orientation sensors 18 include a location sensor (e.g., global positioning system (GPS) sensor) and one or more direction sensor (e.g., compass, pitch, roll and yaw sensors). In one embodiment, the orientation sensors 18 are configured to provide orientation information including location information (e.g., latitude, longitude, altitude coordinates) of display apparatus 10 and direction information corresponding to a direction (e.g., heading, roll, pitch, yaw) in which a display screen of the display apparatus 10 is pointed. Some of the embodiments are described with respect to outdoor media interaction. In other embodiments, the subject space may also comprise an indoor space. Accordingly, orientation sensors 18 may be configured to interact with an indoor positioning system (e.g., beacons) to provide location information in one possible implementation.

According to additional aspects, orientation sensors 18 are configured to provide information regarding a distance between the display apparatus 10 and the user during media consumption. Orientation sensors 18 may be aimed at the user during viewing of images to provide distance information representative of the distance. The distance information may be utilized to determine field of view information which processing circuitry 14 may access to control the depiction of images by a display device of the apparatus 10 as described further below. In one embodiment, orientation sensors 18 may comprise a sonar sensor to provide the distance information.

Image sensor 20 is configured to generate image data corresponding to light received by image sensor 20. Image sensor 20 may comprise a plurality of light sensitive elements (e.g., CMOS, CCD devices) arranged in an array and configured to provide digital image data of a plurality of pixel locations. Although not shown, other optics such as a lens, optical filter, etc. may also be provided.

User interface 22 is configured to interact with a user including conveying media data to a user (e.g., displaying image data for observation by the user, audibly communicating audio data to a user, etc.) as well as receiving inputs from the user (e.g., tactile input, voice instruction, etc.). Accordingly, in one exemplary embodiment, the user interface 22 may include a display device 24 (e.g., cathode ray tube, LCD, etc.) configured to depict visual information and an audio system as well as a keyboard, mouse or other input device. For real world interactive embodiments described herein, a border about the display device 24 may be made as small as possible to reduce interference of the border during depiction of images. Any other suitable apparatus for interacting with a user may also be provided.

External device 26 may include communications circuitry (not shown) configured to implement communications with respect to display apparatus 10. External device 26 may include storage circuitry comprising a database of media data of a plurality of media items in one embodiment. Accordingly, external device 26 may comprise respective storage circuitry and processing circuitry to implement addressing operations including read and write operations with respect to the database. As described further below, the processing circuitry may process received requests for media items (e.g., requests received from display apparatus 10) and control external communication of media data for the requested media items (e.g., for communication to display apparatus 10). Although the communications circuitry, processing circuitry and storage circuitry are not depicted in FIG. 1, such circuitry may be configured similarly to the respective circuitry of display apparatus 10 in one embodiment.

As mentioned above, display apparatus 10 may be configured in different embodiments. The illustrated embodiment of FIG. 1 may correspond to a portable implementation intended to be carried by a user and to provide interaction and consumption at different locations of a real world space. In another embodiment, display apparatus 10 may be provided at a fixed location; (e.g., desktop implementation) to provide interaction and consumption relative to a virtual representation of a space and one or more of the components of FIG. 1 may be omitted. For example, the orientation sensors 18 or image sensor 20 may be omitted in at least one embodiment.

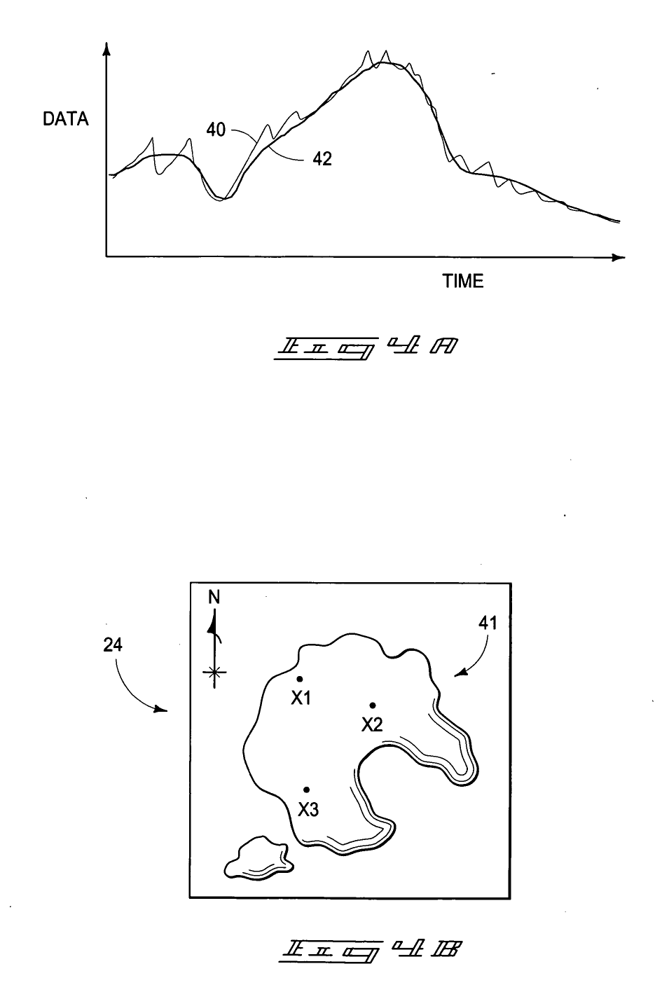

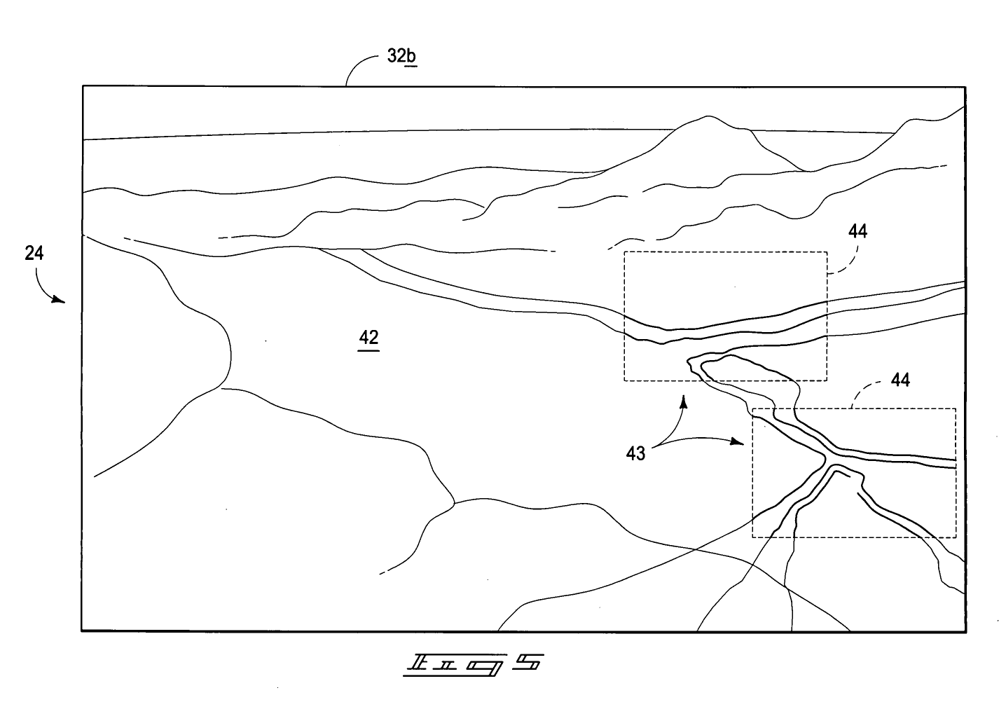

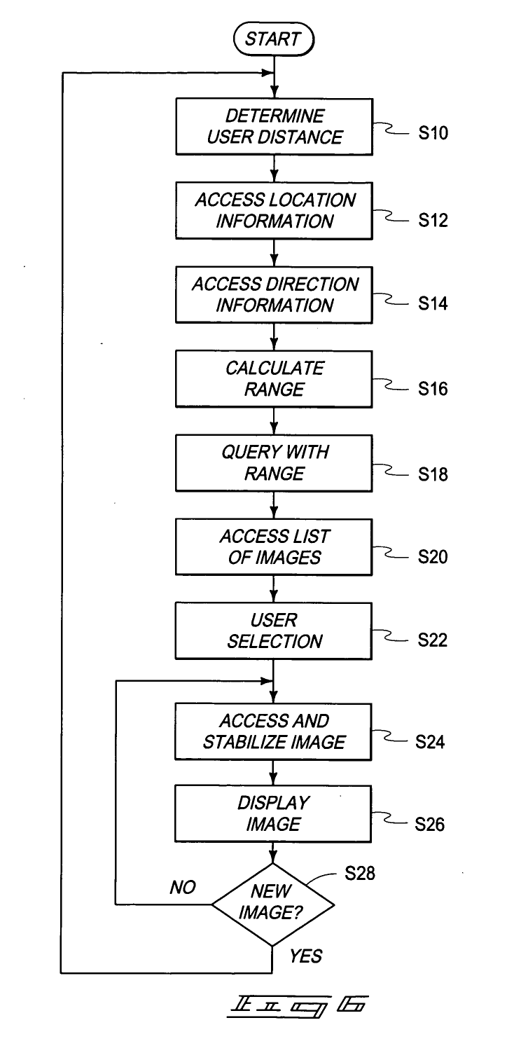

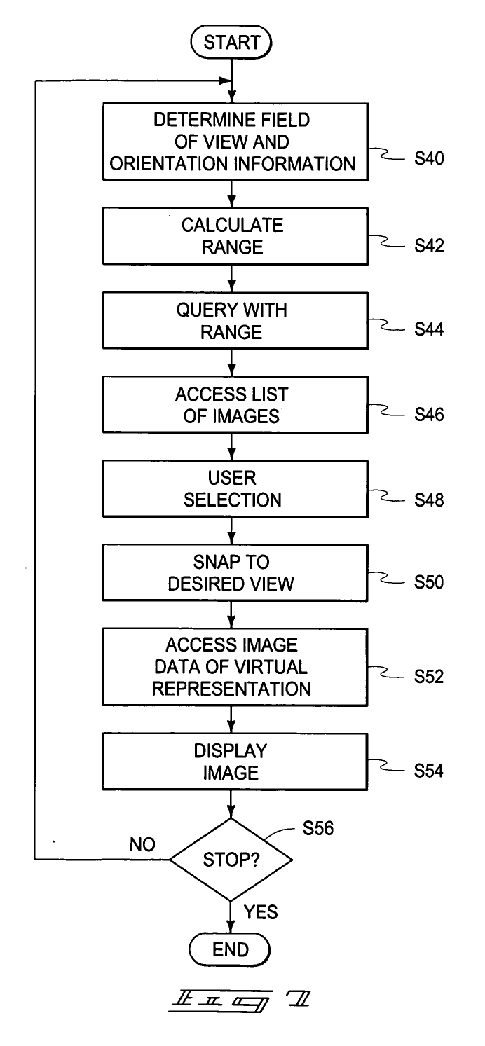

Some aspects of the disclosure are directed towards methods and systems configured to interact with a space, such as a real world environment. Display apparatus 10 configured for portable use may be utilized to provide the interaction in one embodiment. Other aspects include methods and systems which provide interaction with a virtual representation of a space (e.g., merging different representations of a given space to form images). Display apparatus 10 configured for desktop or fixed use may be utilized in one example. Exemplary aspects of real world embodiments are described with respect to FIGS. 3A-4B and aspects of virtual embodiments are described with respect to FIG. 5.

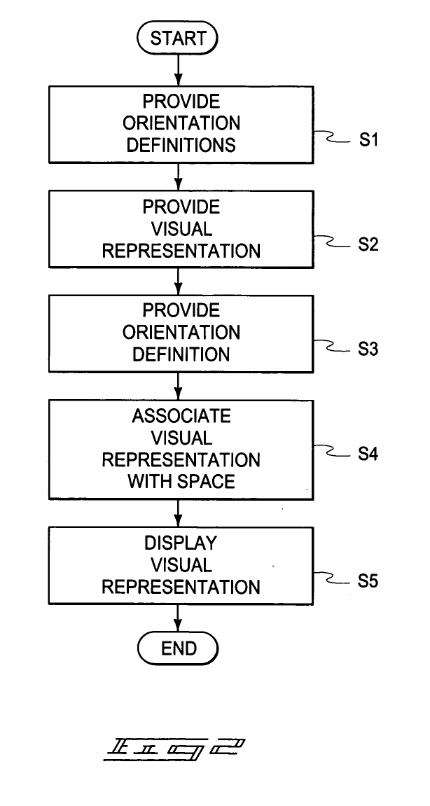

Referring to FIG. 2, an exemplary method for interacting with a space or a virtual representation of a space is illustrated. Other interaction methods including more, less or alternative steps are possible.

At a step S1, a plurality of orientation definitions are provided. The orientation definitions may be provided for a plurality of media items (e.g., visual representations corresponding to respective views of a space) and are indicative of orientation and location of a capture device which captured the media items in one embodiment. The orientation definitions may be provided within a database in one embodiment.

At a step S2, one or more media items (e.g., visual representations) corresponding to views of a space are provided. For example, files of the visual representations may be stored within a database.

At a step S3, one of the orientation definitions may be provided to access one of the respective visual representations stored with the database.

At a step S4, the provided orientation definition may be used to associate the visual representation with the space. In real word interaction embodiments, the visual representation may be associated with real world space. In virtual interaction embodiments, the visual representation may be associated with a virtual representation of the space.

At a step S5, the visual representation may be displayed associated with real world space or a virtual representation of space.

In one embodiment, display apparatus 10 interacts with a real world space or environment, such as the outdoors, and may be provided in a portable implementation. Display apparatus 10 is arranged to depict visual representations (e.g., images) associated with the environment about the display apparatus 10. One example is shown in FIGS. 3A-3D.

In the described example, external device 26 may be provided at a fixed location of the space (e.g., at an observation point adjacent to the bridge shown in FIGS. 3A-3D). A person proximately located with respect to the external device 26 may be able to access media data including image data from the external device 26 using a properly configured display apparatus 10. For image consumption, display apparatus 10 is configured to receive image data from external device 26, to associate the image data with the environment or space, and to display the image data upon display device 24 wherein the displayed image is associated with space as viewed by the user. For example, the image data may comprise an object and features of the object may be aligned with features of real world space.

In one embodiment, the orientation sensors 18 are configured to provide real time orientation information regarding the display apparatus 10 held by the user. As mentioned above, exemplary orientation information may include location information (e.g., GPS coordinates) and direction information (e.g., heading, pitch, roll, yaw information of the direction of the display device 24 as viewed by a user). Display apparatus 10 may communicate the orientation information in a request for media data to the external device 26. External device 26 may reply with a signal or other indication to apparatus 10 that media is present which corresponds to the present location of the display apparatus 10. In another embodiment, user interface 22 of display apparatus 10 may generate a visual/audible alarm or indicator (e.g., a beep, a flashing light, etc.) that media exists which was captured at a location approximately the same as the present location of the display apparatus 10.

A graphical user interface may also be provided to direct a user to locations where media data is available. For example, referring to FIG. 4B, display device 24 of display apparatus 10 may generate a graphical user interface which displays locations wherein media is present and the user may proceed to one of the locations to consume the corresponding stored media. For example, image 41 includes a plurality of reference points X1-X3 upon a map. Media including a plurality of images may be associated with individual ones of the reference points X1-X3. Reference points X1-X3 may identify locations of a space wherein the respective images were captured. A user may proceed to position themselves at one of the reference points X1-X3 to access media associated with the selected reference point. Once positioned, the display apparatus 10 may communicate respective orientation information of apparatus 10 via a request to an external device 26 co-located at the selected reference point in an attempt to access media data. As mentioned above, the database of media may be stored internally of apparatus 10 and accessed while the user is present at a reference point in other implementations.

Display apparatus 10 may also assist with directing a user from one of the reference points (e.g., X1) to another of the reference points (e.g., X2) having associated media data. For example, the display device 24 may include directions (e.g., “move Northeast for 0.5 miles”) to direct the user to another reference point.

Processing circuitry of external device 26 is configured to access the orientation information of a request and to retrieve respective media data (e.g., image data) from the database which corresponds to the orientation information. More specifically, in one embodiment, the database is configured to store image data for a plurality of images. Metadata may be associated with individual ones of the images and indicate the location and direction in which the respective image was obtained. The request from display apparatus 10 may request any image(s) which correspond to the present orientation information (e.g., location and direction) of the display apparatus 10. The processing circuitry of external device 26 accesses the request and the communicated orientation information and compares the received orientation information with respect to orientation definitions of the images of the database to identify appropriate images. For example, the processing circuitry attempts to identify images which were taken at the same location and direction as the current orientation of the display apparatus 10. In one embodiment, a match may be determined if one or more image of the database is found to correspond to the current orientation information of the display apparatus 10 within an acceptable tolerance. Additional details regarding exemplary matching are described below.

The external device 26 may communicate a list of matching images to the display apparatus 10. Responsive to the reception of the list of matching images, processing circuitry 14 of display apparatus 10 may control display device 24 to depict an interface (e.g., graphical user interface) requesting the user to select a desired one or more of the identified images for display.

Display device 24 may implement indexing operations to assist a user with selection of media data corresponding to the location of the user and display device 24. For example, display device 24 may generate a list of media data (e.g., images) organized in any convenient format (e.g., time, subject matter of the media data, etc.) and the user may select specific images of the media data to be experienced. In a more specific example, a list may arrange media data by year and a user may select a desired year of media to experience. In one example, a user can browse back and forth in time to see how scenery changes.

Following identification of one or more appropriate images by the user, the processing circuitry 14 passes the identification to the external device 26 which may communicate the image data and any other media data of the respective selected images to the display apparatus 10.

Display apparatus 10 is configured to receive the image data from external device 26. Processing circuitry 14 of the display apparatus 10 may control the display device 24 of the display apparatus 10 to depict the visual representation(s) comprising image(s) associated with the view of the space as indicated by the orientation information provided by the display apparatus 10. Exemplary details regarding the association are described further below. If a plurality of images are identified and received, a user may select desired ones for viewing (e.g., corresponding to different moments in time when the images were generated, time of day, or according to other criteria). The images may be displayed individually or simultaneously by the display apparatus 10.

In addition to the above-described exemplary arrangements, the media data may be provided in any suitable manner including via sources other than external device 26 as mentioned above. In some examples, the media data may be stored within storage circuitry 16 of display apparatus 10, for example stored on a portable medium (e.g., CD ROM) inserted into display apparatus 10. Other configurations are possible.

Referring again to FIGS. 3A-3D, an exemplary view 30 of a real world space (e.g., outdoor environment 31) by a user is shown. FIG. 3B illustrates a frame 32 corresponding to a display (e.g., screen) of the display device 24. The frame 32 contains the visual representation comprising image 34 generated by display device 24 using the accessed image data. The exemplary image 34 is a historical boat in the example of FIGS. 3A-3D and was captured at some previous point in time. The displayed image 34 may be associated with the environment 31 to give the user the impression of viewing the image 34 at the time when the image was captured. In one embodiment, the association of the image 34 and the environment 31 aligns features of environment 31 with features of image 34 (e.g., display device 24 illustrates the boat positioned at the location when the image 34 was captured). In one implementation, it is desired to provide a display device 24 which provides the smallest border possible about the frame 32 to give a seamless impression of the image 34 merged with scenery of the environment 31. In one exemplary embodiment, images 34 generated by display device 24 responsive to received image data include objects (e.g., the boat of FIGS. 3B-3D) which may be superimposed upon the environment as discussed below. In other embodiments, images 34 may include objects as well as environment and may fill the entire frame 32.

As shown in FIG. 3B, the depicted media of the image 34 may be smaller than the frame 32 provided by the display device 24. Accordingly, an entirety of the image 34 may be viewed by the user during some media consumption.

In other embodiments, the depicted media of the image may be greater than the frame and only a portion of the image may be viewable at a given moment in time. Referring to the example of FIGS. 3C-3D, display device 24 provides a frame 32a smaller than frame 32. The user may move the display device 10 around to view an entirety of the image 34. For example, a user may start with the position of frame 32a initially as shown in FIG. 3C and move the display device 10 upwards to depict the image 34 shown by frame 32a in FIG. 3D.

During movement, orientation sensors 18 provide the direction in which display apparatus 10 is being moved so processing circuitry 14 may monitor the movement and provide new image data to display device 24 for display and corresponding to the movement. The additional image data may be retrieved in real time from external device 26 or from buffered storage in storage circuitry 16 and accessed in response to the movement in possible embodiments. Whether an entirety of the image or only a portion of the image may be displayed may be determined using exemplary matching aspects using field of view information of the user and the image discussed below.

The display apparatus 10 may be located at different distances from the user during use. For example, different users may hold display apparatus 10 at different distances from their eyes. In one embodiment, processing circuitry 14 is configured to utilize field of view information to determine an aspect ratio to control the size of images 34 depicted using display device 24 to match the environment 31 in which display apparatus 10 is being utilized.

Processing circuitry 14 may first determine the field of view provided by the display apparatus 10 at a given moment in time (i.e., the field of view is greater the closer the eye of the user is to the display device 24). In one embodiment, processing circuitry 14 utilizes distance information provided by orientation sensors 18 which is indicative of the distance the display apparatus 10 is from the user. Using the distance information and the size of the frame 32 generated by the display device 24, processing circuitry 14 calculates the field of view provided by the display apparatus 10 for the given distance of use. Other embodiments may be used for determining distance information or the field of view.

Image data for images 34 to be displayed by display device 24 may have associated metadata which indicates the field of view of the respective images 34. In another embodiment, the metadata includes information which may be utilized to calculate the respective field of view. Exemplary metadata information may include the focal length of the lens utilized to capture the image and the size of the sensor of the camera utilized to generate the image data which processing circuitry 14 may use to determine the respective field of view information of the images 34.

The field of view provided by the display apparatus 10 at a given moment and time and the field of view corresponding to an image to be displayed provide zoom information which comprises an aspect ratio which may also be referred to as a zoom factor. Using the zoom factor, processing circuitry 14 may scale the size of the image 34 being displayed to match the field of view of the user according to the distance between the display apparatus 10 and the user. The scaling of the image data permits the display device 24 to depict the images superimposed with respect to the space (e.g., real world or a virtual representation of the real world).

Processing circuitry 14 may control the display device 24 to depict an entirety of the image data for the image (e.g., FIG. 3B) if it is determined that all of the image may be displayed following the scaling and according to the orientation of the display apparatus 10. Alternatively, display device 24 may be controlled to only depict a portion of the image during viewing (e.g., FIGS. 3C and 3D).

As mentioned above, audio data may also be provided associated with respective images (e.g., audible sounds recorded at the location of the camera during the capture of the images). The audio data may be associated with respective ones of the images and respective portions of the audio data may be accessed and played using user interface 22 during the display of respective images. The content of the audio data may be associated with a view of the space in at least some embodiments. In some embodiments, 3-D audio systems or surround systems may be used to control the audible sounds conveyed to the user dependent upon the direction of the view of the space as indicated by the output of orientation sensors 18.

In some embodiments, image data from image sensor 20 may be combined with media data being depicted for images 34 to present a more natural representation of images 34. For example, image sensor 20 may be mounted in a direction opposite to display device 24 in at least one embodiment. For example, display device 24 may display images in one direction and image sensor 20 may, be oriented to simultaneously capture image data resulting from a view in the opposite direction. For the example of FIGS. 3A-3D, portions of environment 31 within frames 32, 32a may be captured by image sensor 20 and displayed via display device 24. Images 34 may be simultaneously superimposed over the real time output of image sensor 20 in one embodiment. Display device 24 may be configured as a semitransparent display in some embodiments to enhance the merging of images 34 with the real world environment 31.

As mentioned above, some aspects are directed towards video implementations as well as still image embodiments. To consume video media, a user may move display apparatus 10 in real time to follow video pan/yaw and tilt while a video is being played. A user may move the display apparatus 10 during playback to follow movement of the video to pan in the direction of the video to maintain the video window centered while panning. A mechanical path tracer may be implemented if the location of the video camera changed during capture of media. For example, a mobile transporter (e.g., car following a track including display device 24) may be controlled by processing circuitry 14 to follow a predetermined path with playback of the media. In other automated aspects, processing circuitry 14 may control the location of the display device 24 as well as the orientation of the display device 24 to play back the media for the user and to maintain depicted images centered within a screen of display device 24.

Referring to FIG. 4A, one embodiment of display apparatus 10 configured to provide real world interaction may be configured to provide processing of orientation information from orientation sensors 18 to depict the images with increased stability relative to environment 31. Referring to FIG. 4A, a representation of stabilization processing implemented by processing circuitry 14 is shown. The stabilization processing provides displayed images with respect to the real world of increased stabilization by reducing the effects of trembling by the user holding the display apparatus 10 and which may be imparted to the display apparatus 10. In one embodiment, processing circuitry 14 is configured to process orientation information provided by orientation sensors 18 using a median filter to provide the stabilization. An exemplary media filter is described in “The Weighted Media Filter”, D.R. K. Brownrigg, Research Contributions, Image Processing and Computer Vision, Vol. 27, No. 8, August 1984, pages 807-818, the teachings of which are incorporated herein by reference. Line 40 of FIG. 4A represents data received from orientation sensors 18 indicative of the orientation information of the display apparatus 10 being held by the user and the associated short and abrupt inputs resulting from user motion. Line 42 represents the filtered output following the stabilization processing which provides orientation information of the orientation of the display of increased accuracy while reducing the effects of unintended user inputs.

Referring to FIG. 5, methods and systems which merge different representations of a given space to form composite images are described. According to at least one embodiment, the display apparatus 10 is configured to depict an initial visual representation of a space (e.g., as opposed to the above-described aspects of FIGS. 3A-3D wherein the display apparatus 10 interacts and associates visual representations with the space comprising the real world environment of the user) as well as media comprising image data providing another visual representation of at least a portion of the space and superimposed with the initial visual representation.

The display apparatus 10 may be configured to execute programming to provide the initial visual representation as a virtual representation of a space, such as a real world environment. An exemplary virtual representation includes a computer graphics animated outdoor world which may be created, for example, from satellite measurements, topographic data, etc. For example, programming may include a geography simulator using Virtual Reality Modeling Language (VRML) discussed in http://www.vrmlsite.com/ and http://wp.netscape.com/eng/live3d/howto/vrml primer body.htmi, the teachings of which are incorporated herein by reference, wherein the virtual representation is an animation of a real world environment. In other aspects, the space may comprise an indoor space and respective aspects would utilize a computer generated model of the indoor space.

In the presently described exemplary embodiment, display apparatus 10 may be provided as a personal computer or workstation. A database of media including a plurality of images may be stored using storage circuitry 16 and accessed by a user of display apparatus 10. Other embodiments are possible.

Referring again to the user interface of FIG. 4B, image 41 depicting reference points X1-X3 may be displayed to begin user interaction in virtual world embodiments. A display screen of display device 24 (e.g., implemented as a computer monitor) may generate image 41. Similar to embodiments described above, image 41 may be generated to assist a user with accessing desired media from storage circuitry 16. With reference to the above-described real world interactive embodiments, reference points X1-X3 referred to locations wherein users may position themselves to consume stored media. In the presently described virtual world embodiments, a plurality of images may be associated with individual ones of the reference points X1-X3. A user may select one of reference points X1-X3 (e.g., via a mouse) to access media associated with the selected reference points. For example, reference points X1-X3 may identify locations of a space wherein respective images were captured and the user may select a desired reference point to access the respective images for viewing in a virtual context.

In another embodiment, the user may experience data at a plurality of points X1-X3 in an order to take a “tour” of media stored along a captured path. Exemplary aspects regarding storage of media along a path are described in the U.S. patent application incorporated by reference above. Other user interfaces configured to assist a user with selection and identification of media to be viewed or otherwise consumed are possible.

Responsive to the selection of a reference point, the processing circuitry 14 may query the user regarding a direction of desired view at the selected location and a field of view. For example, using user interface 22, the user may pan around at the location and select a desired direction and field of view. In other embodiments, the selection of the location and direction of a view may be implemented in other ways such as automatically by the processing circuitry 14 corresponding to the respective image data associated with the reference point.

Referring to FIG. 5, exemplary aspects regarding merging of different visual representations of a space (e.g., the outdoors) are illustrated. Frame 32b is configured to generate a first visual representation 42 of the space. The first visual representation 42 may comprise an animated virtual representation in one embodiment (e.g., 3D virtual representation of the outdoors for example with shading). The first visual representation 42 provides a view of the virtual space from a virtual location corresponding to one of the reference points X1-X3 selected by the user. The view is provided in a desired virtual direction from the selected virtual location.

As mentioned above, once a virtual location of the space is selected, the user may specify the virtual direction and field of view to view the space from the specified location. The selected location and direction of a desired view provides orientation information corresponding to the desired view (e.g., processing circuitry 14 may determine the orientation information from the programming used to provide representation 42). The orientation information may include location information corresponding to the selected reference point as well as direction information including heading, pitch, roll or yaw information or the view at the reference point.

Processing circuitry 14 may search a database of images stored within storage circuitry 16 to locate images which correspond to the orientation information of the desired view. Metadata comprising orientation definitions may be associated with individual ones of the images corresponding to views of a space. The orientation definitions may include location information (e.g., GPS coordinates) and direction information (e.g., heading, pitch, roll or yaw information) when the respective images where captured and which may be saved as metadata of the images. Processing circuitry 14 may search the metadata of the images to identify images of the database having orientation definitions which match the orientation information within a tolerance or range as described further below.

For example, as shown in FIG. 5 a plurality of images 43 may be identified for the depicted view of the space and displayed as second visual representations 44 of the space. Exemplary second visual representations 44 may comprise photographic images 43 of the space while the first visual representation 42 may comprise animation of the space as mentioned in the presently-described exemplary embodiment. Accordingly, in one embodiment, the different visual representations 42, 44 comprise different types of data. In another embodiment, the different visual representations 42, 44 may comprise image data obtained at different moments in time.

As shown in FIG. 5, processing circuitry 14 is configured to merge the image data of the second visual representations 44 with the image data of the first visual representation 42 for display using frame 32b corresponding to a display screen of display device 24. Exemplary merging includes replacing portions of the first visual representation 42 with the second visual representations 44. The image data of the second visual representations 44 replaces co-located image data of the first visual representation 42.

In one embodiment, the merging aligns features of images 43 of the second visual representations 44 with features of the space of the first visual representation 42. Similar to the exemplary aspects described above, processing circuitry 14 may use field of view information to implement scaling operations of images 43 to provide matching of the first and second visual representations 42, 44 permitting superimposition of the image data of the images 43 with respect to the visual representation 42.

For example, the field of view information provided by the frame 32b may be determined from the programming which provides the first visual representation 42. As described above, processing circuitry 14 may execute animation programming instructions in one arrangement to create the first visual representation 42 and may extract the field of view information from the programming. As described above, processing circuitry 14 may also calculate field of view information from metadata of the images 43. The field of view information of the first and second visual representations 42, 44 provide an aspect ratio or zoom factor which may be utilized to scale the image data of the images 43 to match the first and second visual representations 42, 44. Processing circuitry 14 may utilize different aspect ratios for scaling of different images 43 to the field of view of the first visual representation 42. Other matching operations are possible in other embodiments.

According to some aspects, a user may enter commands via user interface 24 and control the view provided by display device 24 within frame 32b. For example, one or more of images 43 may comprise a panorama image and a user may input commands to scroll in different directions to view additional portions of currently displayed images 43, view new images 43 or additional portions of first visual representation 42. In addition, processing circuitry 14 may also direct a user viewing images at one location to another location (e.g., by placing an “X” on the visual representation 42).

According to additional aspects, processing circuitry 14 may control display device 24 to depict video information. For example, in one aspect, images 43 may comprise video images displayed at one moment in time (e.g., additional images 43 (not shown in FIG. 5) may be temporally related to the depicted images). Processing circuitry 14 may control the viewing of the images 43 merged with first visual representation 42 without user control. In such an embodiment, processing circuitry 14 may access orientation information of images 43 according to a sequence in which the images 43 were generated and control display device 24 to depict the images in an order according to the sequence. The first visual representation 42 may move with the video being played to provide a frontal view of the video window to a user. For example, in the case of a left to right pan, the video images 43 may be positioned towards the center of the display device 24 facing the user while the first visual representation 42 pans right to left in the background.

As mentioned above, respective audio data associated with respective images 43 may be played using user interface 22 during depiction of the respective images 43. Similar to video, audio data may be provided as a time dependent signal and audio data may be displayed according to the depiction of the respective video images 43 being displayed. In one embodiment, processing circuitry 14 controls the viewing of the video images 43 as well as the respective audio data. In one possible implementation, 3D audio or surround effects may be provided corresponding to the view of the virtual space being experienced by the user.

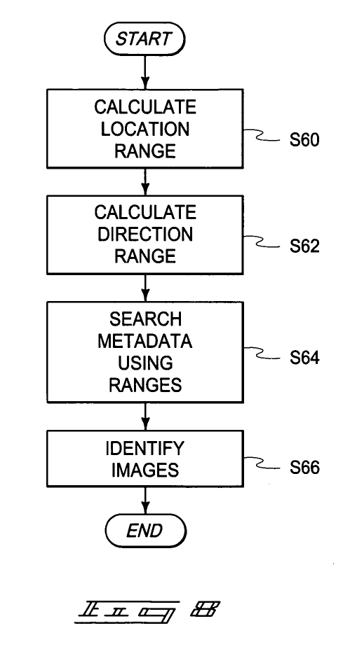

Referring to FIGS. 6 and 7, exemplary methods are depicted which may be implemented by processing circuitry 14 in illustrative embodiments. FIG. 6 depicts one possible method for controlling display apparatus 10 to illustrate images associated with a real world representation of the space. FIG. 7 depicts one possible method for controlling display apparatus 10 to illustrate images associated with a virtual representation of a space. Other methods are possible including more, less or alternative steps.

In the example of FIG. 6, the processing circuitry initially determines the distance between the display apparatus and the user at a step S10. In one example, the processing circuitry accesses distance information from the orientation sensor.

At a step S12, the processing circuitry accesses location information of the display apparatus from the orientation sensor.

At a step S14, the processing circuitry accesses direction information (e.g., heading, pitch, roll, yaw) of the display apparatus from the orientation sensor.

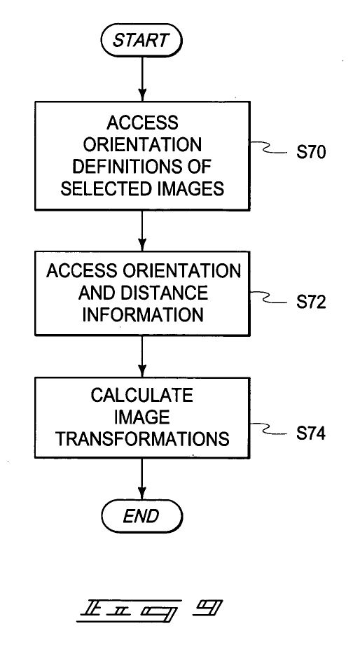

At a step S16, the processing circuitry calculates a range to search for images corresponding to the orientation information of the display apparatus. Additional details regarding an exemplary method for calculating the range are described below with respect to FIG. 8.

At a step S18, the processing circuitry formulates a request or query using the range to search the database of images in an attempt to identify candidate images for viewing by the user. Additional details regarding an exemplary method for formulating the query with the range are described below with respect to FIG. 8.

At a step S20, the processing circuitry obtains results of the request submitted in step S18. The results may be presented to a user for example using a graphical user interface.

At a step S22, the user may select desired image(s) to be viewed via the user interface.

At a step S24, the processing circuitry may obtain orientation information of the display apparatus 10 to access the appropriate image data for the selected image from the database. The processing circuitry may select all or only a portion of the image data for viewing according to the matching of the image to the real world environment. Processing circuitry may also monitor user movements of the display apparatus using information from the orientation sensor and implement stabilization filtering to enable depiction of the image having increased stability.

At a step S26, the processing circuitry controls the display device of the display apparatus to depict the respective image.

At a step S28, the processing circuitry may monitor for the presence of a request from the user to depict another image (e.g., previously identified in step S20).

If no request is received at step S28, the processing circuitry may return to step S24 to update the orientation of the display device, to access any new image data (e.g., from image sensor 20), and to implement stabilization operations.

If a request is received at step S28, the processing circuitry may return to step S10 to repeat the process with respect to a new image.

Referring to the virtual interactive embodiment of FIG. 7, the processing circuitry initially proceeds to a step S40 to determine information from the programming providing the virtual representation of the space. The processing circuitry may obtain field of view information and orientation information comprising location information of the viewing location and direction information.

At a step S42, the processing circuitry may calculate a desired range for use in searching for appropriate images corresponding to the location information and the direction information. As mentioned above, additional details regarding an exemplary process for calculating the range are described below with respect to FIG. 8.

At a step S44, the processing circuitry formulates a request or query including the range to search the database of images in an attempt to identify candidate images for viewing by the user. Additional details regarding an exemplary method for formulating the query with the range are described below with respect to FIG. 8.

At a step S46, the processing circuitry may access a list of images which satisfy the criteria of the request. The results may be presented to a user for example using a graphical user interface.

At a step S48, the user may select a desired image to be viewed via the user interface.

At a step S50, the processing circuitry may snap to the desired view of the virtual representation of the space (e.g., desired virtual location, direction of view and field of view).

At a step S52, the processing circuitry accesses the image data of the virtual representation of the space corresponding to the desired location, direction and field of view.

At a step S54, the processing circuitry superimposes the image data of the selected images (e.g., photograph(s) or other representation) with the virtual representation and controls the display device to depict the merged representations.

At a step S56, the user may indicate whether they wish to cease the method. The processing circuitry may return to step S40 to monitor for a change of the view (e.g., responsive to user input) if no stop request is received. Otherwise, the illustrated method may cease if a stop request is provided.

Referring to FIG. 8, an exemplary method which may be performed by processing circuitry for formulating a request to query a database of candidate images using orientation information is illustrated according to one embodiment. The processing circuitry may utilize orientation information including direction information (e.g., heading, pitch, roll, yaw) and location information as well as specified tolerances to search for images. Other methods are possible including more, less or alternative steps.

At a step S60, the processing circuitry calculates a range of locations to search the database of images. Tolerances may be provided to enable searching of nearby images for possible display to the user or accommodate for errors within the location sensors. An exemplary range for GPS location coordinates include:
Latitude +/−tol_lat
Longitude +/−tol_long
Altitude +/−tol_alt
   “Latitude”, “longitude” and “altitude” refer to measured output of the display apparatus. An exemplary tolerance for GPS location coordinates may be +/−2 meters or better.

At a step S62, the processing circuitry calculates a directional range (e.g., heading, pitch, roll, yaw) to search the database of images. Tolerances may be provided to enable searching of nearby images for possible display to the user or accommodate for errors within the orientation sensors. An exemplary directional range may be defined as follows:
Pitch +/−tol_pitch
Roll +/−tol_roll
Yaw +/−tol_yaw
   “Pitch”, “roll” and “yaw” refer to measured output of the display apparatus. An exemplary tolerance for direction is +/−5 degrees.

At a step S64, the processing circuitry performs the searching by comparing the orientation definitions of the metadata of the respective images of the database with criteria defined by the ranges determined by steps S60 and S62 in one embodiment. For example, the processing circuitry identifies images wherein the respective orientation definitions meet the following criteria:
Latitude_im >Latitude−tol_lat
Latitude_im <Latitude +tol_lat
Longitude_im >Longitude−tol_long
Longitude_im<Longitude +tol_long
Altitude_im >Altitude−tol_alt
Altitude_im <Altitude +tol_alt
Pitch_im >Pitch−tol_Pitch
Pitch _im <Pitch +tol_Pitch
Roll_im>Roll−tol_roll
Roll_im<Roll +tol_roll
Yaw_im >Yaw−tol_yaw
Yaw_im<Yaw +tol_yaw
   wherein the “_im” variables refer to variables of the orientation definitions of the images or other media being searched.

At a step S66, the processing circuitry may provide a list of images which satisfy the criteria. A user may observe the list, for example using a graphical user interface of the display device, and select one or more desired image in one embodiment.

Referring to FIG. 9, an exemplary method which may be performed by processing circuitry for matching identified images to be depicted with respect to the real world or a virtual representation of the world is illustrated according to one embodiment. Other methods are possible including more, less or alternative steps.

At a step S70, the processing circuitry accesses respective orientation definitions (e.g., location and direction information) and field of view data from metadata of the selected images to be depicted.

At a step S72, the processing circuitry accesses orientation information (e.g., location and direction information) of the display apparatus and distance information indicative of the distance between the user and the display apparatus for depicting the selected images.

At a step S74, the processing circuitry may calculate image transformations using the orientation definitions and the orientation information of the display device, dimensions of the screen of the display device, land distance information of the display device with respect to a user to provide the image data of the images at proper pixel locations for association with either the real world space of the virtual space. The association in accordance with one embodiment identifies proper pixel locations for displaying the selected images wherein features of the selected images are aligned with features of either the real world or the virtual representation of the space. Exemplary image transformations incorporating zoom information for providing the matching include:
Translation_{—}Y=Display_pixel_height * distance_to_user * tangent(Pitch_user−Pitch_im)/display_height
Translation_{—}X=Display_pixel_width * distance_to_user * tangent(Yaw_user−Yaw_im)/display_width
θ =rotation_angle=roll_user−roll_im
Rotation: Points [x,y]^{T} are rotated by θ when

$$[ \begin{matrix}F \\ G\end{matrix} ] = [ \begin{matrix}cos ( θ & - sin ( θ ) \\ sin ( θ ) & cos ( θ )\end{matrix} ] [ \begin{matrix}x \\ y\end{matrix} ] + [ \begin{matrix}0 \\ 0\end{matrix} ]$$

Additional details regarding image transformations to associate the selected images with the real or virtual representations of the space are described in “Computer Graphics: Principles and Practice”, Foley, van Dame, Feiner, Hughes, 1990 Addision-Wesley Publishing, the teachings of which are incorporated herein by reference.

Following the determination of the transformations, the processing circuitry 14 may control the display device 24 to depict the image(s) at appropriate pixel locations of the display device 24 as determined by the transformations. For the real world embodiments, the processing circuitry 14 may control the display device 24 to depict the images at the appropriate pixels locations corresponding to the orientation and distance information of the display device 24. For the virtual embodiments, the processing circuitry may replace data of the virtual representation with the image data of the selected image(s) at appropriate pixel locations of the display device 24 as determined by the transformations. A user may control zooming operations of the displayed image to zoom in or out as desired.

At least some aspects of the disclosure utilize data from sensors to search media of a database for associations with real world space or virtual representations of a space. Relatively recent miniaturization of sensors (accelerometers, torsion, compasses, altimeter, GPS, 3D Audio, GMT data, etc.) permit enabled multimedia capture devices to gather informative metadata regarding captured assets including sound, still images or video images.

The protection sought is not to be limited to the disclosed embodiments, which are given by way of example only, but instead is to be limited only by the scope of the appended claims.

What is claimed is:

1. An imaging method comprising:
providing a plurality of orientation definitions corresponding to a plurality of respective views of a space;
providing a visual representation corresponding to one of the views of the space;
providing one of the orientation definitions corresponding to the visual representation;
using the one of the orientation definitions, associating the visual representation of the one view with the space; and
displaying the visual representation associated with the space.

2. The method of claim 1 wherein the orientation definitions individually comprise location information corresponding to a location from which a respective one of the views is observed and direction information corresponding to a direction of the view.

3. The method of claim 1 wherein the providing a visual representation comprises providing a plurality of visual representations corresponding to respective ones of the orientation definitions and the views of the space, and selecting one of the visual representations.

4. The method of claim 3 wherein the selecting comprises selecting responsive to user input.

5. The method of claim 3 wherein the providing the one of the orientation definitions comprises providing before the providing the visual representation, and the selecting comprises selecting responsive to the providing the one of the orientation definitions.

6. The method of claim 3 wherein the displaying comprises displaying using a display device, and further comprising moving the display device, and providing orientation information corresponding to the moving, and wherein the selecting comprises matching the orientation information to the one of the orientation definitions corresponding to the one of the visual representations.

7. The method of claim 1 further comprising determining zoom information with respect to the displaying and wherein the associating comprises associating using the zoom information.

8. The method of claim 7 wherein the displaying comprises displaying the representation using a display device, providing distance information regarding a distance intermediate a user and the display device, and determining the zoom information using the distance information.

9. The method of claim 1 further comprising generating audible sounds corresponding to the visual representation during the displaying of the visual representation.

10. The method of claim 1 wherein the space comprises real world space.

11. The method of claim 1 wherein the space comprises a virtual representation of real world space.

12. The method of claim 1 wherein the displaying comprises displaying the visual representation comprising a video representation.

13. An imaging system comprising:
storage circuitry configured to store image data of a plurality of visual representations of a space, wherein the storage circuitry is further configured to store orientation data comprising a plurality of orientation definitions corresponding to respective ones of the visual representations and indicative of location and directions of a plurality of views of the space utilized to obtain the respective visual representations;
an interface configured to access a request corresponding to one of the orientation definitions and the respective one of the visual representations; and
processing circuitry coupled with the interface and the storage circuitry and configured to access the request, to identify image data of the one of the visual representations using the one of the orientation definitions, and to render the image data of the one of the visual representations available for visual depiction responsive to the request.

14. The system of claim 13 further comprising a display device configured to visually depict the one of the visual representations with respect to the space.

15. The system of claim 14 further comprising an image sensor configured to generate image data and the processing circuitry is configured to control the display device to depict the image data from the image sensor simultaneously with a visual depiction of the one of the visual representations.

16. The system of claim 14 wherein the display device is movable and the request comprises orientation information corresponding to a direction of the display device, and wherein the processing circuitry is configured to access the orientation information and to match the orientation information to the one of the orientation definitions corresponding to the one of the visual representations to identify the image data of the one of the visual representations.

17. The system of claim 16 wherein the processing circuitry is configured to filter the orientation information to provide visual depiction of the one of the visual representations having increased stability.

18. The system of claim 14 wherein the processing circuitry is configured to determine zoom information and to control the display device to visually depict the one of the visual representations with respect to the space using the zoom information.

19. The system of claim 18 further comprising a sensor configured to provide information regarding a distance intermediate a user and the display device, and wherein the processing circuitry is configured to determine the zoom information using the distance.

20. The system of claim 13 wherein the orientation definitions individually comprise location information corresponding to a location from which a respective one of the visual representations was observed and direction information corresponding to a direction from which the respective one of the visual representations was observed.

21. An imaging system comprising:
a display device configured to visually depict a visual representation of a view of a space;
a sensor configured to provide orientation information corresponding to a viewing orientation of the display device with respect to the space; and
processing circuitry coupled with the display device and the sensor and configured to access image data of the visual representation, to access the orientation information of the display device, and to control the display device to depict at least a portion of the visual representation using the image data and the orientation information in accordance with the viewing orientation of the display device.

22. The system of claim 21 wherein the visual representation has an associated orientation definition corresponding to the view of the space and the processing circuitry is configured to access the image data using the orientation information and the orientation definition.

23. The system of claim 21 further comprising storage circuitry configured to store image data regarding a plurality of visual representations of the view of the space and wherein the visual representations have a plurality of orientation definitions corresponding to respective ones of the visual representations.

24. The system of claim 23 wherein the processing circuitry is configured to access the orientation information from the sensor, to match the orientation information with one of the orientation definitions, and to select the one of the visual representations responsive to the matching.

25. The system of claim 21 wherein the processing circuitry is configured to monitor the orientation formation and to control the display device to depict at least an other portion of the visual representation responsive to the monitoring.

26. The system of claim 21 further comprising storage circuitry configured to store image data for a plurality of visual representations, and wherein the processing circuitry is configured to access image data of the visual representations using the orientation information comprising location information of the display device with respect to the space.

27. The system of claim 26 wherein the processing circuitry is configured to access the image data of the visual representation using the orientation information comprising direction information corresponding to directions of view of the display device with respect to the space.

28. An imaging system comprising:
a display device configured to depict visual images of a space; and
processing circuitry coupled with the display device and configured to control the display device to depict a first visual representation of the space as viewed in a given viewing direction from a given viewing location, to access a second visual representation corresponding to the given viewing direction and given viewing location, to merge the first and second visual representations of the space, and to control the display device to depict the merged first and second visual representations of the space as viewed from the given viewing direction and the given viewing location.

29. The system of claim 28 wherein the first visual representation comprises an animation representation and the second visual representational comprises a photographic representation.

30. The system of claim 28 wherein the processing circuitry is configured to access orientation information regarding the given viewing direction and the given viewing location and to identify the second visual representation responsive to the orientation information.

31. The system of claim 28 further comprising storage circuitry configured to store image data regarding a plurality of second visual representations of a plurality of views of the space and wherein the processing circuitry is configured to select and access image data of the second visual representation from the storage circuitry.

32. The system of claim 31 wherein a plurality of second visual representations are associated with a plurality of respective orientation directions, and the processing circuitry is configured to access orientation information regarding the given viewing direction and the given viewing location, and to associate the orientation information with one of the orientation directions corresponding to the merged one of the second visual representations.

33. The system of claim 28 wherein the processing circuitry is configured to replace a portion of the first visual representation with the second visual representation to merge the first and second visual representations.

34. An article of manufacture comprising:
media comprising programming configured to cause processing circuitry to perform processing comprising:
accessing orientation information corresponding to a view of a space, wherein the orientation information comprises location information and direction information from which the view of the space is observed;
using the orientation information, selecting image data for one of a plurality of visual representations of the space;
using the orientation information, associating the image data for the one of the visual representations with the space; and
controlling depiction of the image data for the one of the visual representations in accordance with the associating.

35. The article of claim 34 wherein a plurality of orientation definitions are indicative of location information and direction information of respective ones of the plurality of visual representations, and wherein the programming is configured to cause processing circuitry to perform processing comprising matching the orientation information with one of the orientation definitions of the one of the visual representations to select the image data for the one of the visual representations.

36. The article of claim 34 wherein the programming is configured to cause processing circuitry to perform processing comprising determining zoom information and wherein the associating comprises associating using the zoom information.
